(19) United States
(12) Patent Application Publication
(10) Pub. No.: US 2022/0405468 A1
(43) Pub. Date: Dec. 22, 2022

(54) FORM FILLING BY VOICE

(71) Applicant: GovPlus LLC, San Juan, PR (US)

(72) Inventor: Guy LELOUCH, San Juan, PR (US)

(21) Appl. No.: 17/807,282

(22) Filed: Jun. 16, 2022

Related U.S. Application Data
(60) Provisional application No. 63/217,406, filed on Jul. 1, 2021.
(60) Provisional application No. 63/213,560, filed on Jun. 22, 2021.

(51) Int. Cl. G06F 40/174; G06F 9/451; G06F 3/16

(52) U.S. Cl. CPC G06F 40/174; G06F 9/453; G06F 3/167

(57) ABSTRACT

Methods, storage media, and systems for completing a form by voice are disclosed. Some embodiments may include answering by a user a plurality of questions that correspond to a plurality of fields on at least one form, confirming that the answers from the user are accurate per a government standard, completing the at least one form with the answers to the plurality of questions, and filing the at least one completed form.

### CROSS-REFERENCE

This application claims the benefit of priority of U.S. Provisional Patent Application Ser. No. 63/213,560 filed Jun. 22, 2021, and also claims the benefit of priority of the U.S. Provisional Patent Application Ser. No. 63/217,406 filed Jul. 1, 2021, the disclosures of which are each incorporated by reference in their entireties for all purposes.

### FIELD OF THE DISCLOSURE

The present disclosure relates to methods, storage media, and systems for completing a form by voice.

### BACKGROUND

These days many people manage their bookkeeping/document processing online. However, once they start an application, like changing their address, updating their Social Security Numbers, asking for Employee Identification Numbers, or applying for a birth certificate for their newborn, it takes significant time to type in all the fields. As a result, people have less and less time to attend to their daily and family duties, especially filling in so many government forms. The last thing they want is to sit in front of a computer and try to understand how to fill out a form, so there are no mistakes and no need to refill the form to get all the paperwork done correctly. They would prefer to fill out their form while doing other tasks like driving, walking, managing the household, etc. In this case, they can do several things at once, increasing their overall productivity and gaining more free time with their family and for activities that matter to them.

Also, older people often have no access to a computer or do not know how to browse the web over the phone/tablet. They are still used to visiting a physical office and talking to a human being to get their task done. In other cases, some users may have a temporary or permanent physical disability and cannot visit the legal entities in person to obtain the governmental documents needed for their pension or compensation. The present disclosure assists the people who are not technologically savvy or do not have the physical option to manage the process by themselves. Their time is saved with the present proprietary software solution.

### SUMMARY

The following embodiments and aspects thereof are described and illustrated in conjunction with methods, media, and systems, which are meant to be exemplary and illustrative, not limiting in scope. In various embodiments, one or more of the above-described problems have been reduced or eliminated, while other embodiments are directed to other improvements.

The present disclosure provides a computerized method for completing a form by voice. The method may include answering by a user a plurality of questions that correspond to a plurality of fields on at least one form. The method may include confirming that the answers from the user are accurate per a government standard. The method may include completing the at least one form with the answers to the plurality of questions. The method may include filing the at least one form.

The present disclosure also provides a non-transient computer-readable storage medium for completing a form by voice. In some embodiments, the computer-readable storage medium may include instructions being executable by one or more processors to answer by a user a plurality of questions that correspond to a plurality of fields on at least one form. In some embodiments, the computer-readable storage medium may include instructions being executable by one or more processors to confirm that the answers from the user are accurate per a government standard. In some embodiments, the computer-readable storage medium may include instructions being executable by one or more processors to complete the at least one form with the answers to the plurality of questions. In some embodiments, the computer-readable storage medium may include instructions being executable by one or more processors to file the at least one completed form.

The present disclosure further provides a system for completing a form by voice. The system may include one or more hardware processors configured by machine-readable instructions for completing a form by voice. The machine-readable instructions may be configured to answer by a user a plurality of questions that correspond to a plurality of fields on at least one form. The machine-readable instructions may be configured to confirm that the answers from the user are accurate per a government standard. The machine-readable instructions may be configured to complete the at least one form with the answers to the plurality of questions. The machine-readable instructions may be configured to file the at least one completed form.

Additional embodiments and features are set forth in part in the description that follows. In part will become apparent to those skilled in the art upon examination of the specification or learned by the practice of the embodiments discussed herein. A further understanding of the nature and advantages of certain embodiments may be realized by reference to the remaining portions of the specification and the drawings, which form a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the scope of the disclosure.

FIG. 1 illustrates a system configured for completing a form by voice.

FIG. 2 illustrates a method for completing a form by voice.

FIG. 3 is a block diagram illustrating an example of a suitable computing system environment where aspects of the present disclosure may be implemented.

### DETAILED DESCRIPTION

The present disclosure provides a software solution that allows the user to significantly shorten the time spent filing the government and other forms. In addition, the user can reach and talk to an agent, such as a live customer service agent or artificial intelligence (AI) virtual assistant or chatbot, over the phone.

“Artificial intelligence,” or “AI,” refers to intelligence demonstrated by machines lacking consciousness and emotionality. “Strong” AI is usually labeled as artificial general intelligence (AGI), while attempts to emulate “natural” intelligence have been called artificial biological intelligence (ABI). An “intelligent agent” is any device or software that perceives its environment and takes actions that maximize its chance of achieving its goals. Generally, “artificial intelligence” often describes machines that mimic “cognitive” functions that humans associate with the human mind, such as “learning” and “problem-solving.” As such, an “artificial intelligence agent” refers to a non-human artificial intelligence agent that mimics human cognition via learning and problem-solving.

An “intelligent virtual assistant” (IVA) or “intelligent personal assistant” (IPA) or “virtual assistant” refers to a software agent that can perform tasks or services for an individual based on commands or questions. The term “chatbot” is sometimes used to refer to virtual assistants generally or specifically accessed by online chat. In certain embodiments, that virtual assistant interprets human speech and responds via synthesized voices.

In certain embodiments, the user dials a dedicated phone number on their cellphone and fills out their government form by voice while simultaneously doing things (such as driving the car or doing household chores). The agent takes the user through the form on a field-by-field basis to ensure the form is filled out correctly without the user having to deal with a computer or any web interface. If the user has any questions along the way about the correctness of the information, they can ask the agent at any time, ensuring that the form is filled out accurately and avoiding potential back and forth with the government. Also, the form filing by voice includes different features related to expanding or managing the user's vital documents, replacing the existing documents with newer versions, receiving the digital document to email/sending to a certain person, and integrating with other related services, such as automatic form completion.

“New data” refers to a distinct category or field that is different from any category or field data that was previously captured. In certain embodiments, the categories or field data are detected based on machine readable data.

In certain embodiments, the encryption algorithm for the encrypted cloud storage is proprietary. In certain embodiments, data encryption is maintained throughout the method.

Without wishing to be bound by theory, not having to refill form data that has previously been captured increases the efficiency of use for a general-purpose computer. The data remain encrypted between forms and do not need to be copied into the clipboard function of the general-purpose computer.

In certain embodiments, the user is verified, for example, using a vital document. In certain embodiments, the user's signature is verified, for example, using a vital document or a third-party signature service, such as DocuSign, Dotloop, or Adobe, or electronic token exchange, such as using a public or private key. In such embodiments, the vital document may be an image file or a certified electronic copy from the issuing government authority, such as a birth certificate, driver's license, or passport. In certain embodiments, the vital document is saved in the encrypted cloud drive for the user to use later, for example, to verify the user's identity, to verify the user's signature, or to submit as supporting documentation for a government application.

In certain embodiments, the form fields supplied by voice match a voice recognition signature for the user. In this way, the form fields are only completed with information that matches the user's voice. In certain embodiments, the form fields are filled in the context of the answers received. In certain embodiments, the method further comprises checking the accuracy of the filled form fields.

In certain embodiments, the method further comprises the user calling a dedicated phone number and processing the call. In certain embodiments, the plurality of questions are asked by one or more human agents. In certain embodiments, the one or more human agents comprise a customer service agent, a form expert, or both.

In certain embodiments, the plurality of questions are asked by a non-human artificial intelligence agent. In certain embodiments, the non-human artificial intelligence agent is a virtual assistant or a chatbot.

In certain embodiments, the method further comprises sending the at least one completed form to the user. Sending the at least one completed form to the user increases efficiency of the form filling operation by providing the user with a copy of the records used to complete the selected governmental application.

In certain embodiments, the user has not physically used a computing device but has only interacted with a human or non-human artificial intelligence agent to complete the at least one form.

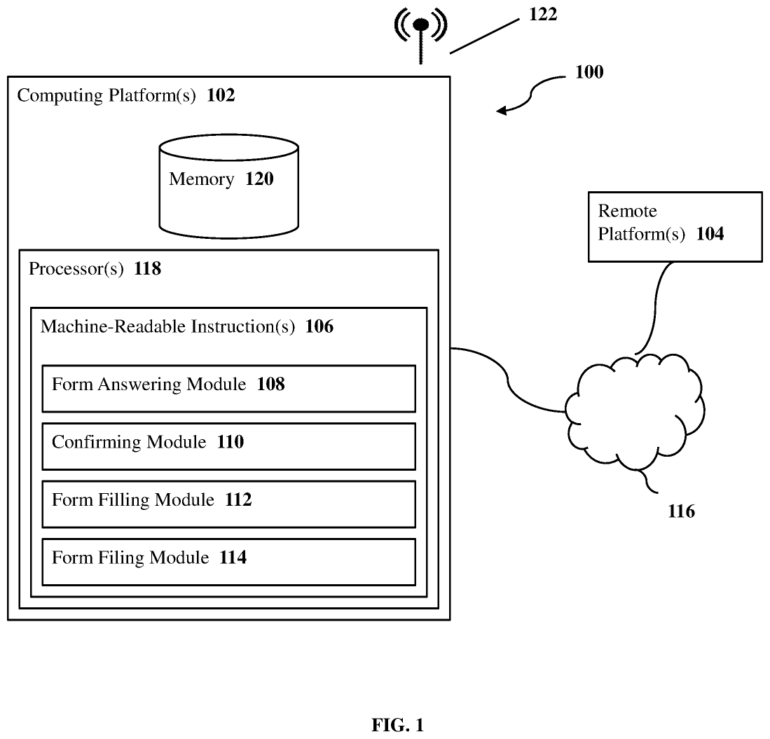

FIG. 1 illustrates a system configured for completing a form by voice per one or more embodiments. In some cases, system 100 may include one or more computing platforms 102. The one or more remote computing platforms 102 may be communicably coupled with one or more remote platforms 104. Users may sometimes access the system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. For example, the modules may include one or more of form answering module 108, confirming module 110, form filling module 112, form filing module 114, and/or other modules.

Form answering module 108 may be configured to answer by the user a plurality of questions that correspond to a plurality of fields on at least one form. Confirming module 110 may be configured to confirm that the answers from the user are accurate per a government standard. Form filling module 112 may be configured to fill out the at least one form with the answers to the plurality of questions. Form filing module 114 may be configured to file the form.

In some cases, the one or more computing platforms 102, may be communicatively coupled to the remote platform(s) 104. In some cases, the communicative coupling may include communicative coupling through a networked environment 116. The networked environment 116 may be a radio access network, such as LTE or 5G, a local area network (LAN), a wide area network (WAN) such as the Internet, or wireless LAN (WLAN), for example. It will be appreciated that this is not intended to be limiting and that the scope of this disclosure includes implementations in which one or more computing platforms 102 and remote platform(s) 104 may be operatively linked via some other communication coupling. For example, the one or more one or more computing platforms 102 may be configured to communicate with the networked environment 116 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices. In an embodiment, system 100 may also include one or more hosts or servers, such as the one or more remote platforms 104 connected to the networked environment 116 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, etc. According to certain embodiments, remote platforms 104 may be standalone servers, networked servers, or an array of servers.

The one or more computing platforms 102 may include one or more processors 118 for processing information and executing instructions or operations. One or more processors 118 may be any general or specific purpose processor. In some cases, multiple processors 118 may be used according to other embodiments. The one or more processors 118 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 118 may be remote from the one or more computing platforms 102, such as disposed within a remote platform like the one or more remote platforms 118 of FIG. 1.

The one or more processors 118 may perform functions for the operation of system 100, which may include, for example, precoding of antenna gain/phase parameters, encoding, and decoding of individual bits forming a communication message, formatting of information, and overall control of the one or more computing platforms 102, including processes related to managing communication resources.

The one or more computing platforms 102 may further include or be coupled to a memory 120 (internal or external), which may be coupled to one or more processors 118, for storing information and instructions that may be executed by one or more processors 118. Memory 120 may be one or more memories and of any type suitable to the local application environment and may be implemented using any suitable volatile or nonvolatile data storage technology such as a semiconductor-based memory device, a magnetic memory device and system, an optical memory device, and system, fixed memory, and removable memory. For example, memory 120 can consist of any combination of random access memory (RAM), read-only memory (ROM), static storage such as a magnetic or optical disk, hard disk drive (HDD), or any other type of non-transitory machine or computer-readable media. The instructions stored in memory 120 may include program instructions or computer program code that, when executed by one or more processors 118, enable the one or more computing platforms 102 to perform tasks described herein.

In some embodiments, one or more computing platforms 102 may also include or be coupled to one or more antennas for transmitting and receiving signals and/or data to and from one or more computing platforms 102. The one or more antennas may be configured to communicate via, for example, a plurality of radio interfaces that may be coupled to the one or more antennas. The radio interfaces may correspond to a plurality of radio access technologies, including one or more of LTE, 5G, WLAN, Bluetooth, near field communication (NFC), radio frequency identifier (RFID), ultrawideband (UWB), and the like. In addition, the radio interface may include components, such as filters, converters (for example, digital-to-analog converters and the like), mappers, a Fast Fourier Transform (FFT) module, and the like, to generate symbols for transmission via one or more downlinks and to receive symbols (for example, via an uplink).

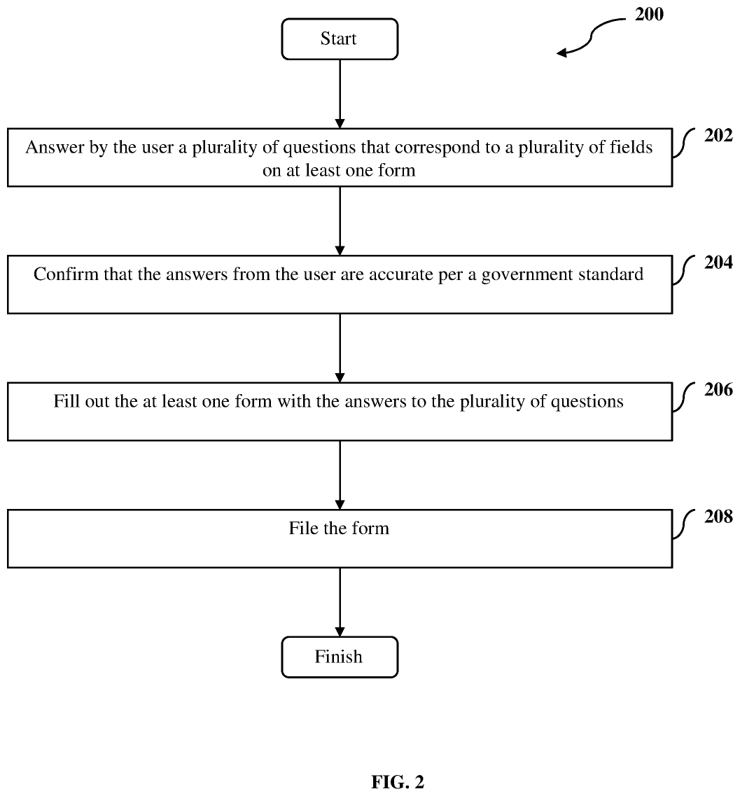

FIG. 2 illustrates an example flow diagram of a method 200, according to one embodiment. Method 200 may include answering by the user a plurality of questions that correspond to a plurality of fields on at least one form at block 202. Method 200 may include confirming that the answers from the user are accurate per a government standard at block 204. Method 200 may include filling out the at least one form with the answers to the plurality of questions at block 206. Method 200 may include filing the form at block 208.

In some cases, method 200 may be performed by one or more hardware processors, such as the processors 118 of FIG. 1, configured by machine-readable instructions, such as the machine-readable instructions 106 of FIG. 1. In this aspect, method 200 may be configured to be implemented by the modules, such as the modules 108, 110, 112, and/or 114 discussed above in FIG. 1.

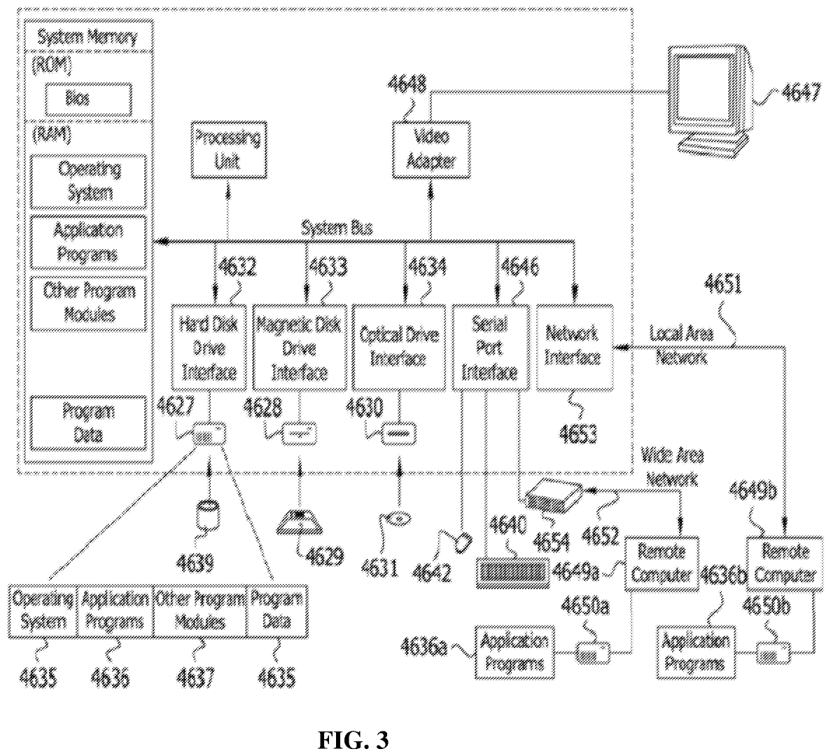

With reference to FIG. 3, an exemplary system for implementing aspects of the disclosure includes a general-purpose computing device in the form of a conventional computer 4620, including a processing unit 4621, a system memory 4622, and a system bus 4623 that couples various system components, including the system memory 4622 to the processing unit 4621. The system bus 4623 may be any of several bus structures, including a memory bus or memory controller, a peripheral bus, and a local bus using various bus architectures. The system memory includes read-only memory (ROM) 4624 and random-access memory (RAM) 4625. In addition, a basic input/output system (BIOS) 4626, containing the basic routines that help transfer information between elements within the computer 4620, such as during start-up, may be stored in ROM 4624.

The computer 4620 may also include a magnetic hard disk drive 4627 for reading from and writing to a magnetic hard disk 4639, a magnetic disk drive 4628 for reading from or writing to a removable magnetic disk 4629, and an optical disk drive 4630 for reading from or writing to removable optical disk 4631, such as a CD-ROM or other optical media. The magnetic hard disk drive 4627, magnetic disk drive 4628, and optical disk drive 4630 are connected to the system bus 4623 by a hard disk drive interface 4632, a magnetic disk drive interface 4633, and an optical drive interface 4634, respectively. The drives and their associated computer-readable media provide nonvolatile storage of computer-executable instructions, data structures, program modules, and other data for the computer 4620. Although the exemplary environment described herein employs a magnetic hard disk 4639, a removable magnetic disk 4629, and a removable optical disk 4631, other types of computer-readable media for storing data can be used, including magnetic cassettes, flash memory cards, digital video disks, Bernoulli cartridges, RAMs, ROMs, and the like.

Program code means comprising one or more program modules may be stored on the hard disk 4639, magnetic disk 4629, optical disk 4631, ROM 4624, and/or RAM 4625, including an operating system 4635, one or more application programs 4636, other program modules 4637, and program data 4638. A user may enter commands and information into the computer 4620 through keyboard 4640, pointing device 4642, or other input devices (not shown), such as a microphone, joystick, gamepad, satellite dish, scanner, or the like. These and other input devices are often connected to the processing unit 4621 through a serial port interface 4646 coupled to the system bus 4623. Alternatively, the input devices may be connected by other interfaces, such as a parallel port, a game port, or a universal serial bus (USB). A monitor 4647 or another display device is also connected to system bus 4623 via an interface, such as video adapter 4648. In addition to the monitor, personal computers typically include other peripheral output devices (not shown), such as speakers and printers.

The computer 4620 may operate in a networked environment using logical connections to one or more remote computers, such as remote computers 4649a and 4649b. Remote computers 4649a and 4649b may each be another personal computer, a server, a router, a network PC, a peer device, or another common network node. These typically include many or all the above elements relative to the computer 4620. However, only memory storage devices 4650a and 4650b and their associated application programs 4636a and 4636b have been illustrated in FIG. 3. The logical connections depicted in FIG. 3 include a local area network (LAN) 4651 and a wide area network (WAN) 4652 presented here by way of example and not limitation. Such networking environments are commonplace in office-wide or enterprise-wide computer networks, intranets, and the Internet.

When used in a LAN networking environment, the computer 4620 is connected to the local network 4651 through a network interface or adapter 4653. When used in a WAN networking environment, the computer 4620 may include a modem 4654, a wireless link, or other means for establishing communications over the wide area network 4652, such as the Internet. The modem 4654, internal or external, is connected to the system bus 4623 via the serial port interface 4646. In a networked environment, program modules depicted relative to the computer 4620 or portions thereof may be stored in the remote memory storage device. It will be appreciated that the network connections shown are exemplary and other means of establishing communications over a wide area network 4652 may be used.

One or more aspects of the disclosure may be embodied in computer-executable instructions (i.e., software), such as a software object, routine, or function (collectively referred to herein as a software) stored in system memory 4624 or nonvolatile memory 4635 as application programs 4636, program modules 4637, and/or program data 4638. The software may be stored remotely, such as on remote computers 4649a and 4649b with remote application programs 4636b. Generally, program modules include routines, programs, objects, components, data structures, etc., that perform particular tasks or implement particular abstract data types when executed by a processor in a computer or other device. The computer-executable instructions may be stored on a computer-readable medium such as a hard disk 4627, optical disk 4630, solid-state memory, RAM 4625, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or, more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of another component (s). The term “segment of code” in the preceding sentence is intended to include one or more instructions or lines of code. Thus, it includes, e.g., code modules, objects, subroutines, functions, and so on, regardless of the terminology applied or whether the code segments are separately compiled, or whether the code segments are provided as a source, intermediate, or object code, whether the code segments are used in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface are encompassed within the definition programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium is wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment accesses functionality performed by a second code segment. Any or all these aspects may be important in a given situation, e.g., depending on whether the code segments are part of a system in a loosely coupled or tightly coupled configuration. So this list should be considered illustrative and non-limiting.

This notion of a programming interface is known to those skilled in the art and is clear from the provided detailed description. Some illustrative implementations of a programming interface may also include factoring, redefinition, inline coding, divorce, and rewriting, to name a few. There are, however, other ways to implement a programming interface. Unless expressly excluded, these are intended to be encompassed by the claims set forth at the end of this specification.

Embodiments within the scope of the present disclosure also include computer-readable media and computer-readable storage media for carrying or having computer-executable instructions or data structures stored thereon. Such computer-readable media can be any available media accessed by a general or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures, and that can be accessed by a general-purpose or special-purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium.

Combinations of the above should also be included within the scope of computer-readable media. Computer-executable instructions comprise, for example, instructions and data which cause a general-purpose computer, special purpose computer, or special purpose processing device to perform a certain function or group of functions.

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

### EP Support Example

Example 1 includes a method comprising: answering by the user a plurality of questions that correspond to a plurality of fields on at least one form, confirming that the answers from the user are accurate per a government standard, and filling out the at least one form with the answers to the plurality of questions and filing the form.

Example 2 includes a storage medium comprising: answering by the user a plurality of questions that correspond to a plurality of fields on at least one form, confirming that the answers from the user are accurate per a government standard, and filling out the at least one form with the answers to the plurality of questions and filing the form.

Example 3 includes a system comprising: answering by the user a plurality of questions that correspond to a plurality of fields on at least one form, confirming that the answers from the user are accurate per a government standard, and filling out the at least one form with the answers to the plurality of questions and filing the form.

Although the subject matter has been described in language specific to structural features and/or methodological acts, it must be understood that the subject matter defined in the appended claims is not necessarily limited to the specific features or acts described above. Rather, the specific features and acts described above are disclosed as example forms of implementing aspects of the present disclosure.

All references, patents or applications, U.S. or foreign, cited in the application are because of this incorporated by reference as if written herein in their entireties. Where any inconsistencies arise, the material disclosed herein controls.

From the preceding description, one skilled in the art can easily ascertain the essential characteristics of this invention. Without departing from the spirit and scope thereof, various changes and modifications of the invention adapt it to various usages and conditions.

What is claimed is:

1. A computerized method for completing a form by voice, the method comprising the steps of:
answering by a user a plurality of questions that correspond to a plurality of fields on at least one form;
confirming that the answers from the user are accurate per a government standard;
completing the at least one form with the answers to the plurality of questions; and
filing the at least one completed form.

2. The method of claim 1 further comprising the user calling a dedicated phone number and processing the call.

3. The method of claim 1, wherein the plurality of questions are asked by one or more human agents.

4. The method of claim 3, wherein the one or more human agents comprise a customer service agent, a form expert, or both.

5. The method of claim 1, wherein the plurality of questions are asked by a non-human artificial intelligence agent.

6. The method of claim 5, wherein the non-human artificial intelligence agent is a virtual assistant or a chatbot.

7. The method of claim 1, wherein the user has not physically used a computing device but has only interacted with a human agent or non-human artificial intelligence agent to complete the at least one form.

8. A non-transient computer-readable storage medium comprising instructions being executable by one or more processors to perform a method for completing a form by voice, the method comprising:
answering by a user a plurality of questions that correspond to a plurality of fields on at least one form;
confirming that the answers from the user are accurate per a government standard;
completing the at least one form with the answers to the plurality of questions; and
filing the at least one completed form.

9. The medium of claim 8 further comprising the user calling a dedicated phone number and processing the call.

10. The medium of claim 8, wherein the plurality of questions are asked by one or more human agents.

11. The medium of claim 10, wherein the one or more human agents comprise a customer service agent, a form expert, or both.

12. The medium of claim 8, wherein the plurality of questions are asked by a non-human artificial intelligence agent.

13. The medium of claim 12, wherein the non-human artificial intelligence agent is a virtual assistant or a chatbot.

14. The medium of claim 8, wherein the user has not physically used a computing device but has only interacted with a human agent or non-human artificial intelligence agent to complete the at least one form.

15. A system for filling a form by voice, comprising:
one or more hardware processors configured by machine-readable instructions to:
answer by a user a plurality of questions that correspond to a plurality of fields on at least one form;
confirm that the answers from the user are accurate per a government standard;
complete the at least one form with the answers to the plurality of questions; and
file the at least one completed form.

16. The system of claim 15, wherein the instructions further comprise the user calling a dedicated phone number and processing the call.

17. The system of claim 15, wherein the plurality of questions are asked by one or more human agents.

18. The system of claim 15, wherein the plurality of questions are asked by a non-human artificial intelligence agent.

19. The system of claim 18, wherein the non-human artificial intelligence agent is a virtual assistant or a chatbot.

20. The system of claim 15, wherein the user has not physically used a computing device but has only interacted with a human agent or non-human artificial intelligence agent to complete the at least one form.
